(19) United States
(12) Patent Application Publication
(10) Pub. No.: US 2005/0094923 A1
(43) Pub. Date: May 5, 2005

(54) Integrated optical isolator using multi-mode interference structure

(75) Inventors: Young-Il Kim, Gyeonggi-do (KR); Tae-Hoon Yoon, Gyeonggi-do (KR); Seok Lee, Seoul (KR); Deok-Ha Woo, Seoul (KR); Sun-Ho Kim, Seoul (KR); Hi-Jung Kim, Seoul (KR); Gwan-Su Lee, Seoul (KR); Sung-Kyu Kim, Seoul (KR); Min-Chul Park, Seoul (KR); Chang-Wan Son, Seoul (KR)

Correspondence Address: HARNESS, DICKEY & PIERCE, P.L.C., P.O. BOX 828, BLOOMFIELD HILLS, MI, 48303, US

(73) Assignee: Korea Institute of Science and Technology, Seoul (KR)

(21) Appl. No.: 10/955,980

(22) Filed: Sep. 30, 2004

(30) Foreign Application Priority Data
Oct. 13, 2003 (KR) 10-2003-0071073

(51) Int. Cl. G02B 6/12

(52) U.S. Cl. 385/14; 385/27

(57) ABSTRACT

The invention relates to a fabrication of an integrated optical isolator using a Multi-Mode Interference (MMI) structure and a cladding layer comprising magneto-optical material, which remove needless reflection generated in the course of light propagation and make short length integration possible. Thus, the invention uses nonreciprocal phase shift effect that optical characteristics are altered according to the direction of light propagation. In order to fabricate a light waveguide optical isolator, an input light should be separated into two light waveguides having the same power. That is, for the purpose of reducing the length of optical isolator device, the waveguide length needed to separate an input light into two light waveguides should be shortened. Since the light waveguide length of MMI structure is much shorter than the length of Mach-Zehnder light waveguide for separating an input light into two waveguides, the length of optical isolator device using MMI structure can be reduced. Moreover, since MMI structure exhibits big permissible error in fabrication, the invention has the advantage that it is simple to fabricate the device.

### BACKGROUND OF THE INVENTION

1. Field of the Invention

The invention relates to an integrated optical isolator, in more detail, to an integrated optical isolator using multi-mode interference (MMI) structure, in which it uses MMI structure and cladding layer composed of magneto-optical material providing nonreciprocal phase shift, removes needless reflection generated in the course of light propagation, and makes the short length integration possible.

2. Description of the Related Art

With the rapid advances in recent fiber-optic communication systems, a high level monolithical integration is required for optical components used in optical communications, especially for diverse optical devices such as an optical modulator, a semiconductor laser and an optical amplifier. In such an optical integration, for the purpose of confirming the stable operation for diverse optical devices, it is essential for optical isolators to prevent diverse optical devices from generating needless reflection in the course of light propagation.

Since the existing optical isolators were fabricated with bulk type magneto-optical material, monolithical integration was impossible; thereby the processes that align each individual optical devices and optical isolators and package them were used. Therefore, it was necessary to develop techniques for integrating optical isolators with optical devices, and it was possible to integrate them through exploiting magneto-optical material magnetized at room temperature.

Currently, there have been active studies on integrated optical isolators using magneto-optical material, and the representatives are the methods that magneto-optical material is used for a guiding layer [J. Fujita et al., Appl. Phys. Lett., 76, 2158 (2000)] and a cladding layer [H. Yokoi, et al., Appl. Opt., 39, 6158 (2000)] of light waveguide.

FIG. 4 is a schematic diagram of a Mach-Zehnder interferometer optical isolator in accordance with an embodiment of a prior art.

Referring to the schematic diagram illustrating in FIG. 4, the existing integrated optical isolator comprises Mach-Zehnder interferometer structure which connects two Y-distributor's (20, 30), separates input light into two lights with two arms (40, 50), and then recombines the separated lights. However for Mach-Zehnder interferometer, the process length of the area of Y-distributor distributing input light is several mm long and the length for separating input light into two arms and recombining the separated lights is mm unit long; thereby the integration for Mach-Zehnder interferometer is restricted in the length.

Numeral 10 not described here is a cladding layer.

### SUMMARY OF THE INVENTION

In one aspect, the invention relates to an integrated optical isolator which provides high level monolithical integration for optical communication devices.

In another aspect, the invention relates to the fabrication of MMI structure-integrated optical isolator for short length integration.

The other aspect of the invention is to fabricate an integrated optical isolator which removes needless reflection in the course of light propagation using a cladding layer which comprises magneto-optical material providing nonreciprocal phase shift.

### BRIEF DESCRIPTION OF THE DRAWINGS

FIG. 1 is a schematic diagram of an integrated optical isolator using MMI structure in accordance with the present invention.

FIG. 2 is a graphical view illustrating the results of BPM simulation of an integrated optical isolator using MMI structure.

FIG. 3 is a graphical view illustrating changes of the length according to the width of MMI.

FIG. 4 is a schematic diagram of a Mach-Zehnder interferometer optical isolator in accordance with an embodiment of a prior art.

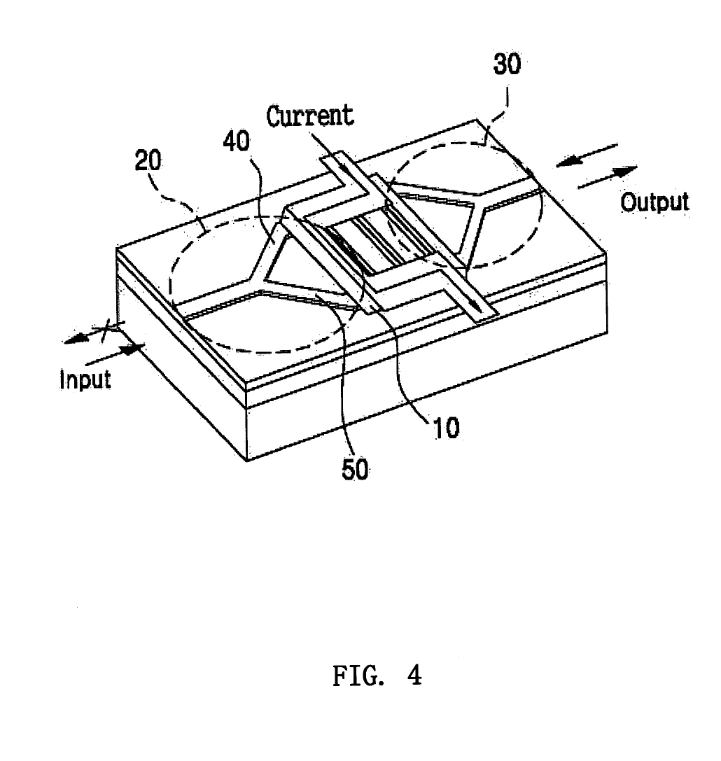

### DESCRIPTION OF THE NUMERALS ON THE MAIN PARTS OF THE DRAWINGS

20, 30: Y-distributor's

40, 50: arms

100: a substrate

110, 120: an MMI light splitter

130, 140: arms

150: a cladding layer

160: an electrode

### DETAILED DESCRIPTION OF THE EMBODIMENTS

The embodiment of the invention provides an integrated optical isolator, comprising a substrate; two MMI light splitters formed by direct wafer bonding method on the said substrate; a cladding layer formed on two arms divided from the said MMI light splitters; an electrode generating opposite directional magnetic field built on the said cladding layer.

The said MMI light splitters are characterized as separating input light into two lights having the same power.

Moreover, the said cladding layer is characterized as being composed of magneto-optical material (Ce:YIG) which provides nonreciprocal phase shift.

The basic theory of the MMI structure is disclosed in Baojun Li, Guozheng Li, Enke Liu, Zuimin Jiang, Jie Qin, Xun Wang, “Low-Loss 1×2 multimode interference wavelength demultiplexer in Silicon-Germanium alloy,” IEEE Photo. Tech. Lett. Vol. 11, pp. 575-577, 1999; and L. B. Soldano and E. C. M. Pennings, “Optical Multi Mode Interference Device Based on Self-Imaging: Principles and Application”, J. Lightwave Technology, Vol. 13(4), pp. 615-627, 1995).

MMI structure has the advantage that input light distribution area is shortened to hundreds of μm long. Therefore, as interferometer using two MMI's which distribute input light and recombine the distributed lights is applied, the optical isolator that the length for input light distribution area is tens to hundreds of an shorter than the length for applying the existing Mach-Zehnder interferometer can be fabricated. Moreover, since MMI structure exhibits big permissible error in fabrication, it is simple to fabricate the device and the yield can be increased.

Hereinafter, referring to appended drawings, the structures and operation principles of the present invention are described in detail.

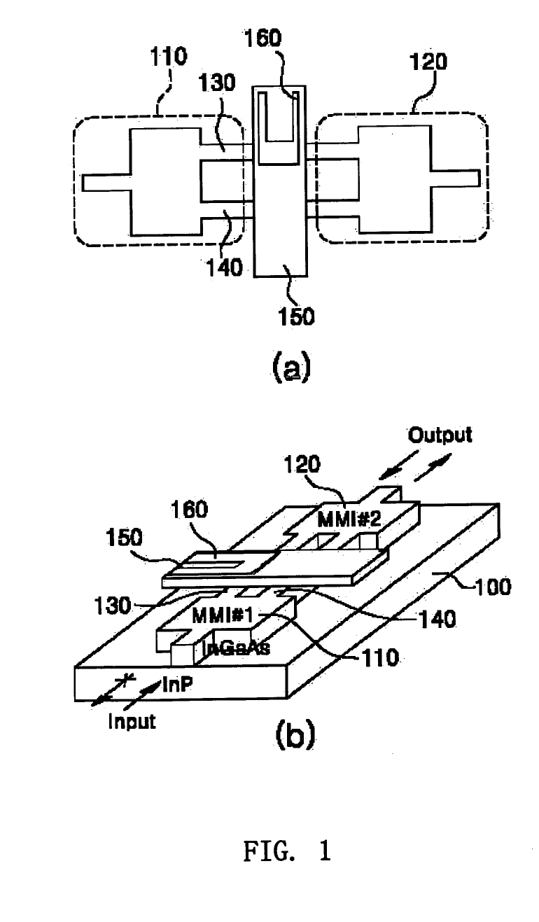

FIG. 1 is a schematic diagram of an integrated optical isolator using MMI structure in accordance with the present invention.

Referring to the schematic diagram illustrated in FIG. 1, the present invention related to an integrated optical isolator comprising a substrate (100), two MMI light splitters (110, 120) formed on the substrate (100) by direct wafer bonding method, a cladding layer (150) formed on two arms (130, 140) divided from the MMI light splitters (110, 120), and an electrode built on the cladding layer (150).

The cladding layer (150) is composed of magneto-optical material (Ce:YIG) which provides nonreciprocal phase shift.

The electrode (160) is in parallel with the plane of MMI light splitters (110, 120) and is designed to generate opposite directional magnetic field, and magnetizes magneto-optical material in the course of current injection.

At the same time, as fabricating so that the path difference of two arms (130, 140) is λ/4, nonreciprocal phase shift of MMI light splitters is made to be λ/4.

The input light is separated into two lights having the same power through MMI light splitters (110, 120). And passing through two arms (130, 140) magnetized to the opposite direction respectively, the input light has opposite directional nonreciprocal phase shift. For example, for the forward direction that the light propagates from the first MMI light splitter (110) to the second MMI light splitter (120), the light propagating to the first arm (130) has λ/8 nonreciprocal phase shift and the light to the second arm (140) has −λ/8 phase shift. Therefore, the nonreciprocal phase shift of two lights becomes −λ/4. And there being λ/4 reciprocal phase shift, the phase shift of two lights in MMI light splitters (110, 120) is to be 0, and then the two lights can be propagated. For the backward direction that the light propagates, however, from the second MMI light splitter (120) to the first MMI light splitter (110), the nonreciprocal phase shift becomes λ/4 and the total phase difference becomes λ/2, therefore the lights is to be cancelled.

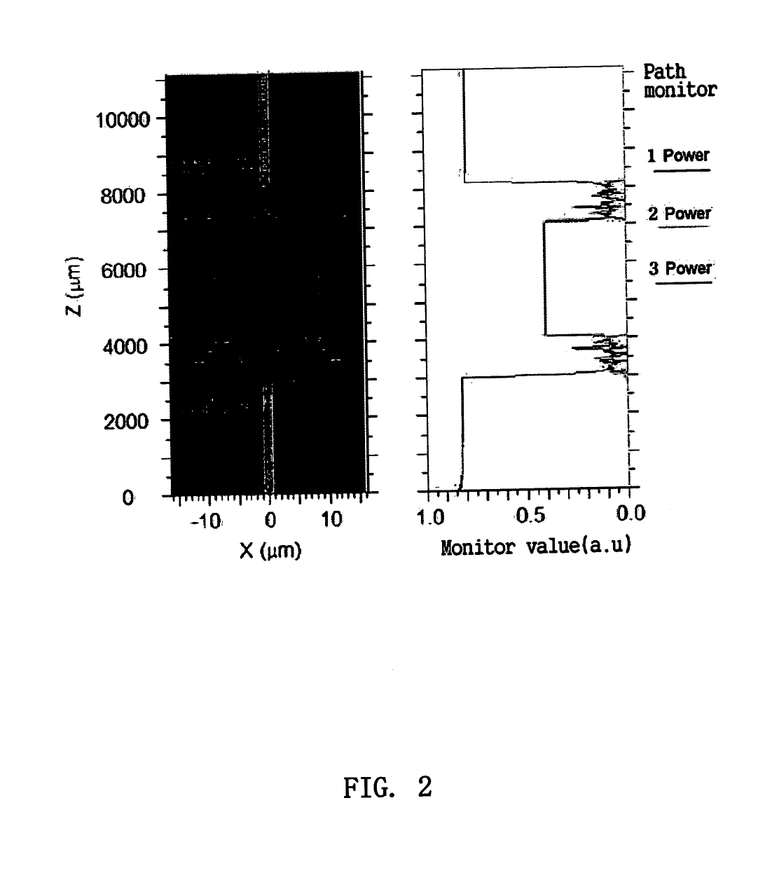

FIG. 2 is a graphical view illustrating the results of BMP simulation of an integrated optical isolator using MMI structure.

Referring to FIG. 2, two input lights toward the first light splitter (MMI#1) are divided into two arms (130, 140) with the same phase, then the divided two output lights are inputted into the second MMI optical splitter (MMI#2), and then the final recombined output light is generated.

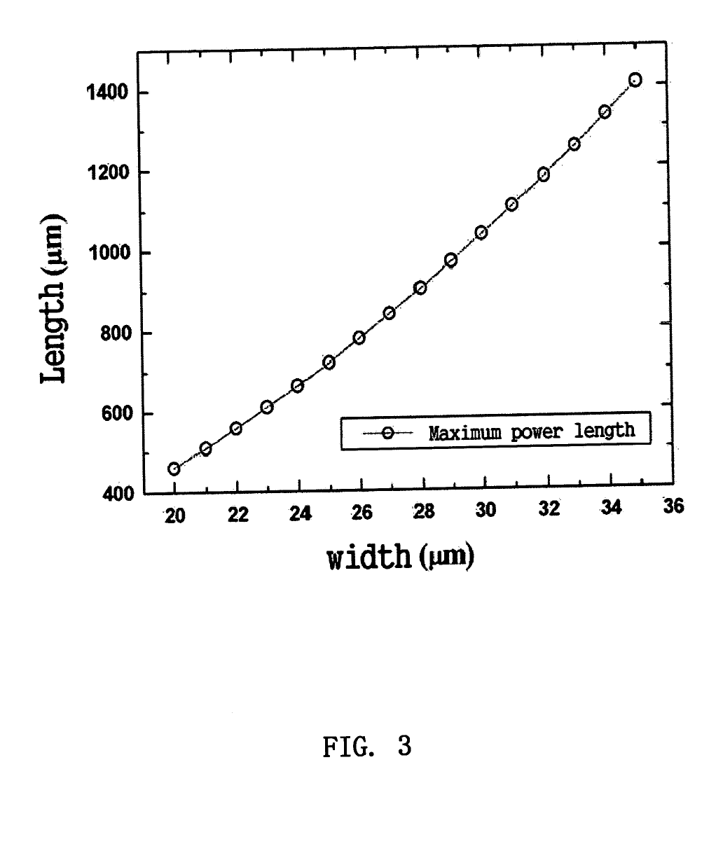

FIG. 3 is the result that analyzes changes of MMI length for MMI width for the case of separating the light into 50:50 in the MMI structure used in FIG. 1. As illustrated in FIG. 3, the result shows that MMI length can be reduced to hundreds of μm according to the change of MMI width.

According to the invention described herein, using the cladding layer comprising magneto-optical material providing MMI structure and nonreciprocal phase shift, the invention provides the advantage that a short length integrated optical isolator can be fabricated.

Moreover, an optical isolator in which the area to distribute the input light is tens of μm to hundreds of μm shorter than that of prior arts can be fabricated, and since MMI structure exhibits big permissible error in fabrication, it is simple to fabricate and the yield can be increased.

Thereby, high level optical integration is possible and thus, the invention influences on the advances of optical information processing systems.

Since those having ordinary knowledge and skill in the art of the present invention will recognize additional modifications and applications within the scope thereof, the present invention is not limited to the embodiments and drawings described above.

1. An integrated optical isolator, comprising: a substrate;
two MMI light splitters formed by direct wafer bonding method on the said substrate;
a cladding layer formed on two arms divided from the said MMI light splitters;
an electrode built on the said cladding layer and generating opposite directional magnetic field.

2. The integrated optical isolator of claim 1, wherein the said MMI light splitters separate the input light into two lights having the same power.

3. The integrated optical isolator of claim 1, wherein the said cladding layer is composed of magneto-optical material (Ce:YIG) which provides nonreciprocal phase shift.
